(19) United States
(12) Patent Application Publication
(10) Pub. No.: US 2026/0171809 A1
(43) Pub. Date: Jun. 18, 2026

(54) Charging Connector for an Aerosol Generating Device

(71) Applicant: JT INTERNATIONAL SA, Geneva (CH)

(72) Inventor: Karima Lakraa, Lausanne (CH)

(73) Assignee: JT INTERNATIONAL SA, Geneva (CH)

(21) Appl. No.: 19/127,481

(22) PCT Filed: Nov. 7, 2023
(86) PCT No.: PCT/EP2023/081026

§ 371 Date: May 6, 2025

(30) Foreign Application Priority Data
Nov. 11, 2022 (EP) 22206962.7

(51) Int. Cl. H02J 7/00; A24F 40/20; H02J 7/70; H02J 50/10

(52) U.S. Cl. CPC H02J 7/00; A24F 40/20; H02J 7/731; H02J 50/10

(57) ABSTRACT

A charging system for an aerosol generating device includes a charger having a device interface part, a first portion of a charging circuit, the first portion of the charging circuit including a first contact pin having a first polarity, a second contact pin having a second polarity opposite to the first polarity, a third contact pin having the same polarity as the first contact pin, an aerosol forming device having a device housing, and including a second portion of the charging circuit, the second portion of the charging circuit including a first device contact and a second device contact. The device interface part of the charger further includes a first securing magnet or group of magnets, and a second securing magnet or group of magnets arranged circumferentially around the third contact pin, the charging cable releasably securable to the aerosol generating device using the magnets or groups of magnets.

### TECHNICAL FIELD

The present invention relates to a charging connector for an aerosol generating device, such as an electronic cigarette. The present invention relates particularly, but not exclusively, to a charging connector between a charging cable and an aerosol generating device.

### TECHNICAL BACKGROUND

Electronic cigarettes are an alternative to conventional cigarettes. Instead of generating a combustion smoke, they vaporize a liquid which can be inhaled by a user. The liquid typically comprises an aerosol-forming substance, such as glycerine or propylene glycol, that creates the vapour when heated. Other common substances in the liquid are nicotine and various flavourings.

Conventional cigarette smoke comprises nicotine as well as a multitude of other chemical compounds generated as the products of partial combustion and/or pyrolysis of the plant material. Electronic cigarettes on the other hand deliver primarily an aerosolized version of an initial starting e-liquid composition comprising nicotine and various food safe substances, such as propylene glycol and glycerine etc., but are also efficient in delivering a desired nicotine dose to the user. Electronic cigarettes need to deliver a satisfying amount of vapour for an optimum user experience whilst at the same time maximizing energy efficiency.

An electronic cigarette is a hand-held inhaler system, typically comprising a mouthpiece section, a liquid store and a power supply unit. Vaporization is achieved by a vaporizer or heater unit which typically comprises a heating element in the form of a heating coil and a fluid transfer element such as a wick. Vaporization occurs when the heater heats the liquid in the wick until the liquid is transformed into vapour.

Another type of aerosol generating device is configured to heat a tobacco substrate contained or wrapped in the form of a stick or pod. Such a device, also referred to as a “heat-not-burn” device, typically comprises an electrical heating element such as an oven, a blade or pin, or an induction heater.

Being hand-held, electronic cigarettes or heat-not-burn devices typically include a battery, which may be a rechargeable battery. In order to recharge the battery within an aerosol generating device, a user may, in some circumstances, remove the battery from the aerosol generating device and place it in an external battery charger. This can be inconvenient for a user however, and risks damage to the device by disassembly. Thus, in other circumstances, the user may instead connect the aerosol generating device including the battery to a charger.

A charger may comprise a charger cable, which is connectable to an external power source (such as a USB or mains connector), or may comprise a charger unit, such as a charging dock or charging case, which may include an independent power source, such as a larger battery, and/or may be connectable to an external power source. In each case, a charging connector is required to connect the aerosol generating device to the charger. A charging connector typically includes a first connector part including two or more contacts on the charger and a second connector part including two or more complementary contacts on the aerosol forming device. When the first and second parts of the charging connector are mated together such that the charger contacts electrically couple to the device contacts, a charging current may flow from the charger to the aerosol forming device in order to charge the battery contained therein.

It is an object of the present invention to provide an improved charging connector.

### SUMMARY

According to a first aspect of the invention we provide a charging system for an aerosol generating device, the system comprising:
a charger having a device interface part, the charger comprising a first portion of a charging circuit, said first portion of the charging circuit comprising a first contact pin having a first polarity, a second contact pin having a second polarity opposite to the first polarity, and a third contact pin having the same polarity as the first contact pin;
an aerosol forming device having a device housing, and comprising a second portion of the charging circuit, said second portion of the charging circuit including a first device contact and a second device contact;
wherein the device interface part of the charger further comprises a first securing magnet or group of magnets arranged adjacent to, preferably circumferentially around, the first contact pin, and a second securing magnet or group of magnets arranged adjacent to, preferably circumferentially around, the third contact pin, the charger being releasably securable to the aerosol generating device using the first and second magnets or groups of magnets;
wherein the first device contact is located so as to form an electrical connection with the first contact pin and/or third contact pin and the second device contact is located so as to form an electrical connection with the second contact pin when the charger is releasably secured to the aerosol forming device, in order to complete a charging circuit.

The charger preferably comprises a recess having a recess surface shaped to receive an end portion of the device housing when the charger is releasably secured to the aerosol forming device, the first, second and third contact pins protruding from the recess surface.

Such a charging system is reversible, in that the charger may be connected to the aerosol generating device in one of two predefined connection orientations. The recess surface forms a seat for the end portion of the aerosol generating device, which combined with the magnetic attraction provides a stable and user friendly connection.

The charger may be a charging cable. Alternatively, the charger may be a charging dock or charging case.

The first securing magnet may comprise a first annular magnet having a centrally located bore, through which at least a portion of the first contact pin extends and protrudes. The second securing magnet may comprise a second annular magnet having a centrally located bore, through which the third contact pin extends and protrudes. This arrangement assists in ensuring a secure and correctly located connection.

The aerosol forming device may include a third securing magnet, wherein the first device contact overlies the third securing magnet. Such a magnet may assist in ensuring a strong yet releasable connection.

The first and third contact pins may be equally spaced on opposite sides of the second contact pin. This contact arrangement is compact yet fully reversible.

The first device contact may surround the second device contact, such that the first device contact forms the electrical connection with both the first contact pin and third contact pin when the charger is releasably secured to the aerosol forming device. The first device contact may be elliptical or rounded rectangular and may be concentric with the second device contact. This contact arrangement is fully reversible whilst having a simplified electrical structure.

The first device contact may be comprised in a contact bracket having at least one coupling flange. Using the coupling flange the contact bracket may be connected to the device housing over the third securing magnet. The contact bracket may thus perform a secondary function of maintaining the third securing magnet in place within the aerosol forming device.

The aerosol generating device may further include a third device contact and a fourth securing magnet, the third device contact overlying the fourth securing magnet, wherein the first and third device contacts are equally spaced on opposite sides of the second device contact. The first and third device contacts may have the same polarity.

The device contacts may not protrude from, and may be flush with, an outer surface of an end portion of the aerosol generating device. This may present an attractive and easy to clean outer device surface.

The recess surface may be at least partially curved and may comprise no corners, and may for example be concave. The outer surface of the end portion of the device may also be at least partially curved and comprise no corners, and may for example be convex. The contact pins may be positioned on or through a flat surface portion of the recess surface. Both the recess surface of the charger and the outer surface of the end portion of the device may be formed of non-deformable (i.e. non-rubbery) material to ensure correct magnetic adjustment and alignment. The device contacts may be positioned on a flat surface portion of the outer surface of the end portion of the device. These features may increase the user-friendliness and the reliability of the connection system, whilst maintaining an attractive appearance.

The recess may be shallow, and may for example have a depth of less than 5 mm, and preferably less than 2 mm. A shallow cavity may assist in locating the end portion of the device housing to achieve a secure connection, while still maintaining visibility of a major portion of the device housing.

The recess surface may have an elliptical or rounded rectangular shape in plan view. The flat portion of the recess surface may be elliptical or rounded rectangular, and may have a major radius that is at least 1.5 times, and preferably at least 2 or 2.5 times, its minor radius. The recess surface may comprise a rim, and a curved land may extend between the flat surface and the rim to form the concave recess surface. The rim may be higher at two opposed edge regions, which may be edge regions lying on the major radius of the recess surface, so as to present a concave curvature when viewed from the side. These features may increase usability by helping to guide the device into the correct orientation within the recess.

In a case where the charger is a charging cable, the cable may comprise a cable part having a thickness and a width, and a cross-section of the cable part may be flattened such that the width is at least 1.5 times the thickness, for example at least 2 times the thickness, or 2.5 times the thickness, or more. Such a cable may resist twining.

The cable may comprise an outer surface shaped to blend smoothly into an external surface of the aerosol generating device when the end portion of the device is located within the recess.

The device interface part may be located at a first end of the cable part and the charging cable may further comprise a power connector located at a second end of the cable part and electrically connected to the first portion of the charging circuit.

The aerosol generating device may further include a rechargeable battery operable to be electrically connected to the second portion of the charging circuit. The battery may be a DC voltage source, such as a Nickel-metal hydride battery, a Nickel cadmium battery, or a Lithium based battery, for example a Lithium-Cobalt, a Lithium-Iron-Phosphate, a Lithium-Ion or a Lithium-Polymer battery. The aerosol generating device may further comprise a processor associated with electrical components of the electronic cigarette, including the battery.

In the context of this disclosure, an aerosol generating device may comprise an electronic cigarette, which may include a cartridge removably connected to a base part, or may comprise a heat-not-burn device configured to receive exchangeable tobacco cartridges. As used herein, the term “electronic cigarette” may include an electronic cigarette configured to deliver an aerosol to a user, including an aerosol for inhalation/vaping. An aerosol for inhalation/vaping may refer to an aerosol with particle sizes of 0.01 to 20 μm. The particle size may be between approximately 0.015 μm and 20 μm. The electronic cigarette or heat-not-burn device may be portable.

It is to be appreciated that the cartridge and the base part may include any one or more components conventionally included in these parts of an aerosol generating device, as discussed in the description below.

The features set out above may be combined together in any combination, and also with features selected from the detailed description below.

### BRIEF DESCRIPTION OF THE DRAWINGS

There now follows a detailed description of the invention, by way of example only, with reference to the accompanying drawings, in which:

FIG. 1 schematically shows an aerosol generating device including a base part and disposable cartridge;

FIG. 2 illustrates an aerosol generating device and charging cable connected together using a charging connector;

FIG. 3 illustrates the charging connector of FIG. 2 in a disconnected state, showing a first portion of the charging connector in the aerosol generating device and a second portion of the charging connector in the charger cable;

FIG. 4 is a cross-sectional view through the charging connector of FIGS. 2 and 3 in a connected state;

FIG. 5 illustrates a further example charging connector in a connected state;

FIG. 6 illustrates the charging connector of FIG. 5 in a disconnected state, showing a first portion of the charging connector in the aerosol generating device;

FIG. 7 illustrates two views of the charger cable partially shown in FIGS. 5 and 6; FIG. 8 is a close up view showing further detail of the second portion of the charging connector of the charging cable shown in FIG. 7;

FIG. 9 is a cross section through a first contact pin of the charging cable shown in FIGS. 6, 7 and 8;

FIG. 10 schematically illustrates a movement range of a contact pin;

FIG. 11 is a cross-sectional view through the charging connector of FIGS. 5 to 9 in a connected state;

FIG. 12 is a perspective view of a charging dock; and

FIG. 13 is a perspective view of a charging system with a charging dock.

### DETAILED DESCRIPTION

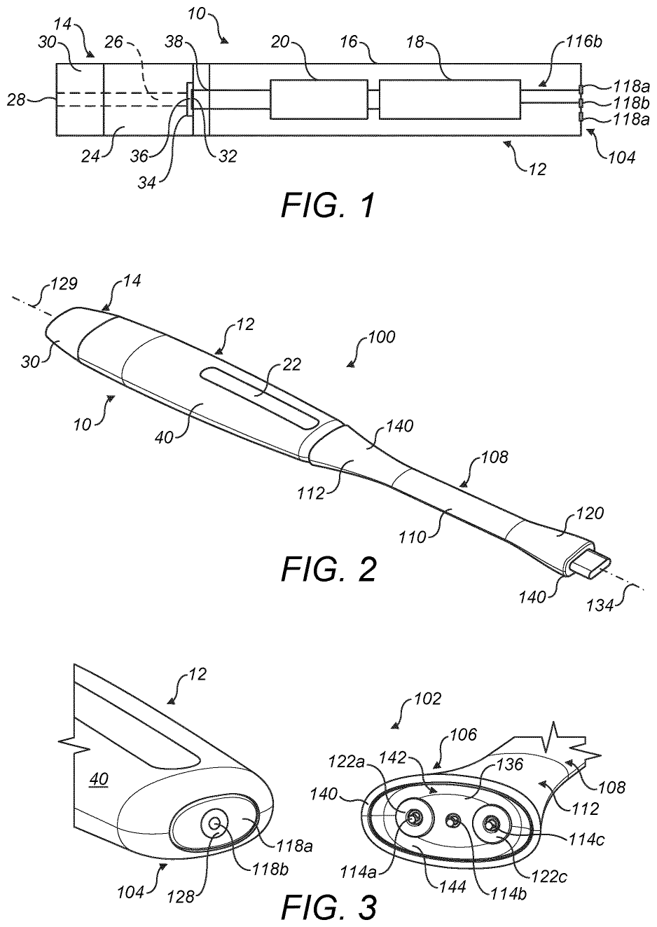

FIG. 1 schematically shows one example of an aerosol generating device 10, such as an electronic cigarette. The aerosol generating device includes a base part 12 and a cartridge 14 (also referred to in the art as a “capsule” or “pod”). The cartridge 14 is removably connectable to the base part 12, and may be disposable. The base part 12 is thus the main body of the electronic cigarette and is generally re-usable.

The base part 12 comprises a housing 16 accommodating therein a power supply unit in the form of a rechargeable battery 18. The aerosol generating device 10 further includes a controller 20 and a user interface 22 for permitting a user to control the operation of the aerosol generating device 18 via the controller 20.

In the example shown in FIG. 1, the cartridge 14 includes a liquid storage reservoir 24 configured for containing therein a liquid to be vaporised. The liquid may comprise an aerosol-forming substance such as propylene glycol and/or glycerol and may contain other substances such as nicotine and acids. The liquid may also comprise flavourings such as e.g. tobacco, menthol or fruit flavour. A vapour transfer channel 26 extends from an air inlet (not shown) to an outlet 28 provided in a mouthpiece region 30 of the cartridge. In FIG. 1, the vapour transfer channel 26 extends through the centre of the of the cartridge but it will be appreciated that this location is exemplary only.

The cartridge 14 further includes a heater unit 32. A fluid transfer element 34 such as a wick is located in fluid communication with the interior of the reservoir 24, and is configured to draw vaporisable liquid from the reservoir 24 towards the heater unit 32 at a vaporisation zone 36. The vaporisation zone 36 is in fluid communication with the vapour transfer channel 26. When the base part 12 is attached to the cartridge 14, power may be supplied to the heater unit 32 from the battery 18 via heater contacts 38 to heat up liquid in the vaporisation zone 36 thereby generating a vapour which cools and condenses to form an aerosol for inhalation by a user of the aerosol generating device 10 through the outlet 26.

In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

Once the liquid within the reservoir has been vaporised, a new cartridge may be attached to the base part and the empty cartridge discarded.

As noted above, the aerosol generating device of FIG. 1 comprises a reusable base part 12 which includes a rechargeable battery 18, permitting a user to use the aerosol generating device 10 many times by recharging the battery when needed.

Referring now to FIGS. 2 to 4, a charging system 100 for an aerosol generating device is described. The charging system 100 includes a charging connector 102 having a first connector portion 104 provided in the aerosol generating device 10 and a second connector portion 106 provided in a charger, such as a charging cable 108, that is connectable to the aerosol generating device 10. It will be appreciated that this arrangement is exemplary, and that the locations of the first and second connector portions 104, 106 could be reversed if required. Furthermore, the charging connector could be provided in a charger other than a charging cable, such as a charging dock or a charging case.

The charging cable 108 has a cable part 110 having a first end and a second end, and a device interface part 112 located at the first end. The charging cable 108, and more specifically the device interface part 112 of the charging cable, includes three contact pins 114, namely a first contact pin 114a having a first polarity, a second contact pin 114b having a second polarity opposite to the first polarity, and a third contact pin 114c having the same polarity as the first contact pin (i.e. also having the first polarity). The contact pins 114 are comprised within a first portion 116a of a charging circuit 116.

A second portion 116b of the charging circuit 116 is included within the base part 12 of the aerosol forming device 10. The second portion of the charging circuit includes at least two device contacts 118, and in the example shown includes a first device contact 118a and a second device contact 118b.

The device interface part 112 of the charging cable 108 further comprises a first securing magnet or group of magnets 122a arranged a least partially circumferentially around the first contact pin 114a, and a second securing magnet or group of magnets 122c arranged a least partially circumferentially around the third contact pin 114c. In an alternative (not illustrated), the magnets 122a, 122c could be positioned adjacent their respective contact pin (e.g., part annular, half-ring or rectangular magnets). The charging cable 108 is releasably securable to the aerosol generating device 10 using the first and second magnets or groups of magnets.

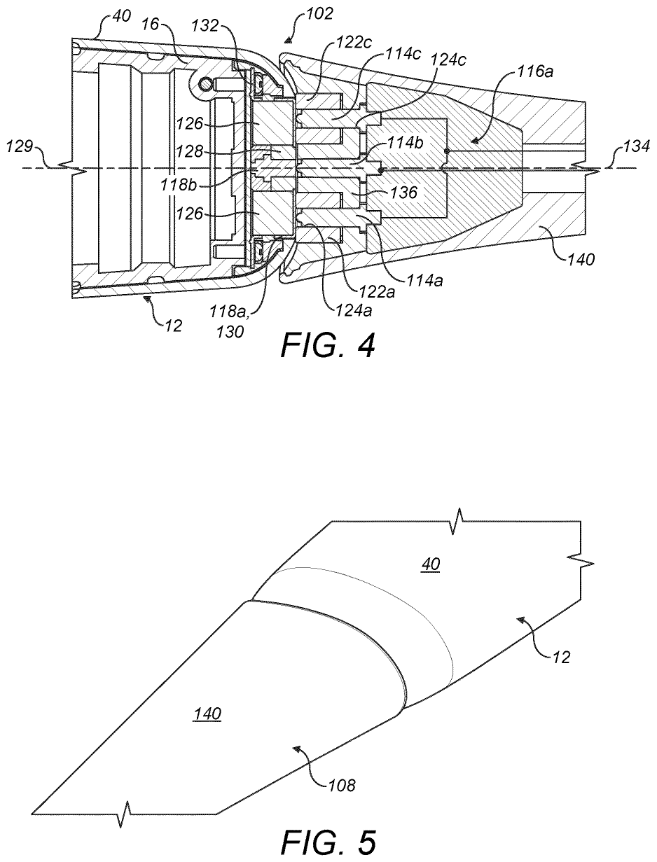

As can be seen most clearly in FIG. 4, the first device contact 118a is located so as to form an electrical connection with the first contact pin 114a and/or third contact pin 114c when the charging cable 108 is releasably secured to the aerosol forming device 10 using the first and second securing magnets. Similarly, the second device contact 118b is located so as to form an electrical connection with the second contact pin 114b when the charging cable 108 is releasably secured to the aerosol forming device 10 using the first and second securing magnets. Electrical connection of these various contacts electrically connects the first and second portions of the charging circuit, so allowing a charging current to flow through the charging cable and into the battery 18.

Because the first and third contact pins 114a, 114c have the same polarity, either of the pins may be used to complete the charging circuit via the first device contact 118a. This means that a user can connect the charging cable to their device in one of two predefined connection orientations. Typically, a charging cable includes a power connector 120 electrically connected to the first portion of the charging circuit and located at a second end of the cable part (i.e. at an opposite end to the first end including the device interface part 112). Any suitable power connector may be included in a charging cable, depending on intended use, such as a mains, USB or USB-C connector. In the case of a power connector which is itself reversible (such as a USB-C connector and the mains connectors of some countries), it can be advantageous for a user to be able to couple a charging cable to their device in more than one orientation.

It will be appreciated that an aerosol generating device itself may have a defined or preferred use orientation. In the example shown in FIG. 2, for instance, the aerosol generating device is non-cylindrical and includes a first (also termed herein “upper”) side having a user interface 22, and a second (also termed herein “lower”) side that is absent primary interface features. It can thus be advantageous to provide a charging cable configured to permit a user to connect their device in one of two predefined orientations. This may be a first “right side up” orientation, as shown in FIG. 2, and a second “upside down” orientation that is 180 degrees opposed to the first orientation. This means that, regardless of which way round the user connects the power connector of the cable to a power outlet, the user is always able to connect their device to the cable in a right side up orientation, ensuring the user interface remains fully visible and usable during charging.

In the example shown, the first securing magnet or group of magnets is provided in the charging cable as a first annular magnet 122a. A bore 124a is located centrally through the annular magnet 122a, through which at least a portion of the first contact pin 114a extends and protrudes. Similarly, in the example shown, the second securing magnet or group of magnets is provided as a second annular magnet 122c. A bore 124c is located centrally through the annular magnet 122c, through which at least a portion of the third contact pin 114c extends and protrudes. Both magnets are arranged with the same magnetic pole uppermost, so as to ensure reversibility of the connection as discussed above.

The securing magnets in the charging cable releasably secure the cable to the aerosol generating device via magnetic attraction. This may be magnetic attraction to a metallic part of the device (such as, for instance, the first contact 118a). Alternatively, as illustrated in FIG. 4, the aerosol forming device may include at least a third securing magnet or group of magnets 126 located so as to magnetically attract and couple with the first and/or second magnets (or groups of magnets) 122a, 122c within the cable.

In the example shown in FIGS. 2-4, the first device contact 118a overlies the third securing magnet or group of magnets 126. In particular, the first device contact 118a is provided as a thin conductive (e.g. metal) plate which overlies a pair of third securing magnets 126. The first device contact 118a surrounds the second device contact 118b, and is separated from the second device contact 11b by an insulator 128. This concentric arrangement permits the first device contact to form an electrical connection with both the first contact pin 114a and the third contact pin 114c when the charging cable is releasably secured to the aerosol forming device. The second device 118b contact is, in the example shown, provided as a contact pin extending through the insulator 128, but could take another form if required. The concentric contacts 188a, 188b are centred on a longitudinal axis 129 of the device.

As visible in FIG. 3, the first device contact 118a is generally oval or elliptical in shape, but may have any shape so long as it remains insulated from the second device contact 118b. In the example shown, the first device contact 118a is comprised in a contact bracket 130 having at least one coupling flange 132 extending away from the first device contact 118a. Using the coupling flange the contact bracket 130 may be connected to the device housing 16 over the third securing magnets 126. The contact bracket 130 may thus perform a secondary function of maintaining the third securing magnets 126 in place within the aerosol forming device.

The charging cable 108 has a longitudinal axis 134, and the second contact pin 114b lies on the longitudinal axis 134 so as to be aligned with the longitudinal axis. The first and third contact pins are located such that the second connector portion 106 has rotational symmetry of order two. This ensures the cable is easily reversible between the two defined use orientations. In the example shown, the first and third contact pins 114a, 114c, are equally spaced on opposite sides of the second contact pin 114b, such that the three contact pins of the charging cable 100 lie in a plane that comprises the longitudinal axis. In addition to rotational symmetry, this arrangement ensures the contact pins are symmetrical about a line of symmetry passing through the second contact and perpendicular to the longitudinal axis, which makes for a more compact cable.

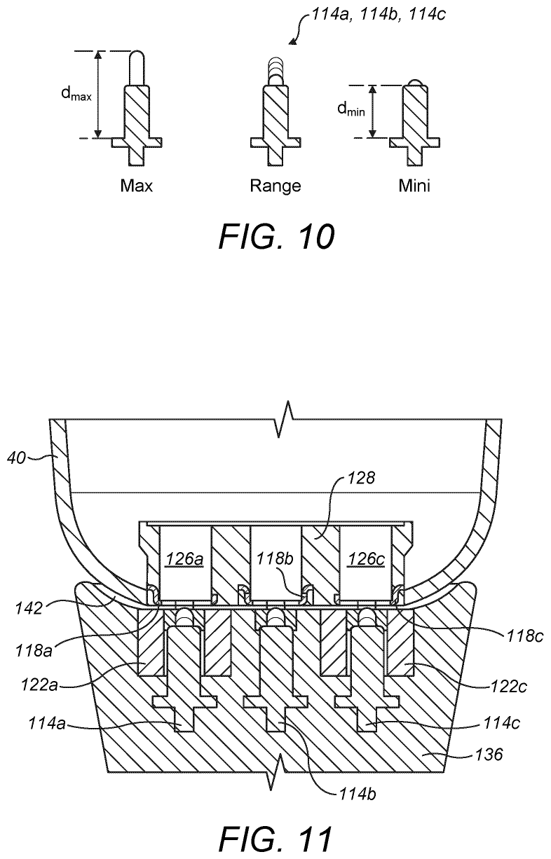

The first, second and third contact pins 114a, 114b, 114c are electrically isolated from one another by insulation 136. The annular securing magnets 122a, 122b are held in cylindrical recesses within the insulation. To ensure a reliable connection, the contact pins may be outwardly biased, and may for example be provided as pogo-pins. As shown best in FIG. 10, a pogo-pin comprises a compressible spring-loaded tip which retracts into a body of the pin under contact pressure, such that the pin has a range of tip positions between a maximum extension dₘₐₓ and a minimum extension dₘᵢₙ (i.e. full compression), with an electrical connection being ensured at any tip position throughout the range.

In the examples shown, the aerosol generating device 12 and the charging cable 108 are shaped to blend smoothly into one another so as to provide a charging system with a substantially continuous appearance. To this end, the housing 16 of the base part of the aerosol generating device 12 is covered with a device outer skin 40 which leaves the first connector part exposed. Similarly, the device interface part 112, cable part 110, and power connector part 120 are covered with a cable outer skin 140, which leaves the second connector part exposed. The device outer skin 40 thus forms an external surface of the aerosol generating device, and the cable outer skin 140 forms an outer surface of the cable 108. The outer skins 40, 140 may be formed of a resilient material such as silicone.

The cable 108, and in particular the device interface part 112, includes a recess 142 from which the first, second and third charging pins 114a, 114b, 114c protrude. The recess 142 is shaped to receive a portion of the aerosol generating device 12 when the charging cable is releasably secured to the aerosol forming device. Specifically, the recess is shaped to receive an end portion of the device 12, said portion comprising the first connector portion. The outer surface of the cable outer skin 140 is shaped to blend smoothly into an external surface of the device outer skin when the portion of the device is secured within the recess by the securing magnets. By “blend smoothly” it is meant that, when connected, the aerosol generating device 12 and the charger cable 108 together present a substantially continuous outer surface, without a marked change of surface direction, as shown in FIGS. 2 and 5.

The recess 142 has a recess surface 144 that includes the exposed surface of the insulator 136 and the exposed surfaces of the securing magnets 122a, 122b. To ensure a smooth appearance, the exposed surfaces of the securing magnets 122a, 122b preferably do not protrude from, and may be flush with, the exposed surface of the insulator 136. The contact pins may be located such that their minimum extension (i.e. fully compressed) position occurs below the recess surface, such that the contact pins maintain an outward bias when the cable 108 is secured to the device 12.

In the examples shown, the recess surface 144 is curved and comprises no angles or corners, so as to present a concave cavity. The cavity is shallow, in that its depth is small compared with its width and height. For example, the depth of the cavity may be less than 5 mm, and preferably less than 2 mm. The depth of the cavity may be between 0.5 mm and 2 mm, or between 0.5 mm and 1.5 mm, and in the example shown is comprised between 0.7 and 1.35 mm. The depth of the cavity may vary, and may be higher at the larger width of the recess than at the shorter width (that is, the cavity may be 2 mm, or 1.5 mm, or 1,35mm at it's largest width, and may be 1 mm, or 0.7 mm, or 0.5 mm at its shortest width). In the example shown, the cavity has a depth of 1.35 mm at its deepest and 0.7 mm at its shallowest.

In plan view, the recess may be elliptical or rounded rectangular, with a major axis that is at least 1.5 times the length of its minor axis. In the example shown, the major axis of the recess is approximately twice the length of the minor axis. A lower surface of the recess, through which the contact pins protrude, is substantially flat so as to improve the ease of connection. Like the overall shape of the recess, the flat recess portion is elliptical or rounded rectangular when viewed in plan view, with a major axis that is at least 1.5 times the length of its minor axis. In the example shown, the major radius of the recess is approximately twice the length of the minor radius. In the example shown, the major radius of the flat recess portion is 2.8 mm, whilst the minor radius is 1.4 mm.

The recess surface may comprise a rim, and a curved land may extend between the flat portion of the recess surface and the rim to form the overall concave recess surface. The flat portion may blend smoothly into the curved land, without a sharp or angular transition. The rim may be higher at two opposed edge regions, which may be edge regions lying on the major radius of the recess surface, so as to present a concave curvature when viewed from the side. This may result in the varying depth of the recess, as discussed above.

The end portion of the aerosol generating device has an outer surface that is shaped to fit within the recess, and which is also curved without angles or corners. As can be seen in FIG. 4, the end portion of the device may have a surface shape which matches, and is substantially the same as, the shape of the recess surface. That is, the end portion of the device housing is convex with an angle of curvature that is substantially the same as that of the concave recess. The device contacts preferably do not protrude from, and may be flush with, the outer surface of the end portion. A portion of the device surface that is shaped to mate with the flat portion of the recess surface may itself be substantially flat.

Prior charging connectors typically comprise a slot, into which a portion of an aerosol forming device may be received, which has substantially vertical side walls that closely surround the portion of the aerosol forming device to maintain it in a coaxial orientation with the slot. Such a slot requires an aerosol forming device to be inserted in a coaxial orientation, which can result in mechanical interference between the slot and the device, which can hinder a mechanical coupling. In contrast, the arrangement described herein presents a smooth bowl-shaped surface with no corners that permits the securing magnets to guide the device and cable into a coupling connection. Furthermore, the relatively smooth connection surfaces are less prone to soiling that connection surfaces including mating protrusions and recesses, which can gather dirt and debris and render a connection unreliable over time. Nevertheless, the charging connector described herein is operable to hold an aerosol generating device and charging cable in coaxial alignment, at least at the connection interface.

The cable part of the charging cable has a thickness t and a width w. A cross-section of the cable part is flattened, for example elliptical or rounded rectangular, such that the width is greater than the thickness, for example at least 1.5 times the thickness, or at least twice the thickness, or at least 2.5 times the thickness. This helps ensure the cable maintains a constant orientation between the power connector 120 and the device interface part 112, without twisting about the longitudinal axis. The silicone body of the cable may have a width in the range 16.5 mm-6 mm and a thickness in the range 8.5 mm-3.5 mm).

The charging cable is also short (in comparison with typical charging cables), and may be of a comparable size to the aerosol generating device 10 itself, for example 15 cm or less, 12 cm or less, or 10 cm or less. In the specific example shown the cable is approximately 9 cm in length. This further resists the cable twining, and helps to ensure the aerosol generating device is held in the defined use orientation when it is secured to the charging cable. The cable and the device further have about the same height so they can easily be stored in a small-length packaging tray without the cable being bent. A short flattened cable of this type is not prone to twining and tends to revert to its initial shape after bending, particularly if formed from a resilient material such as silicone.

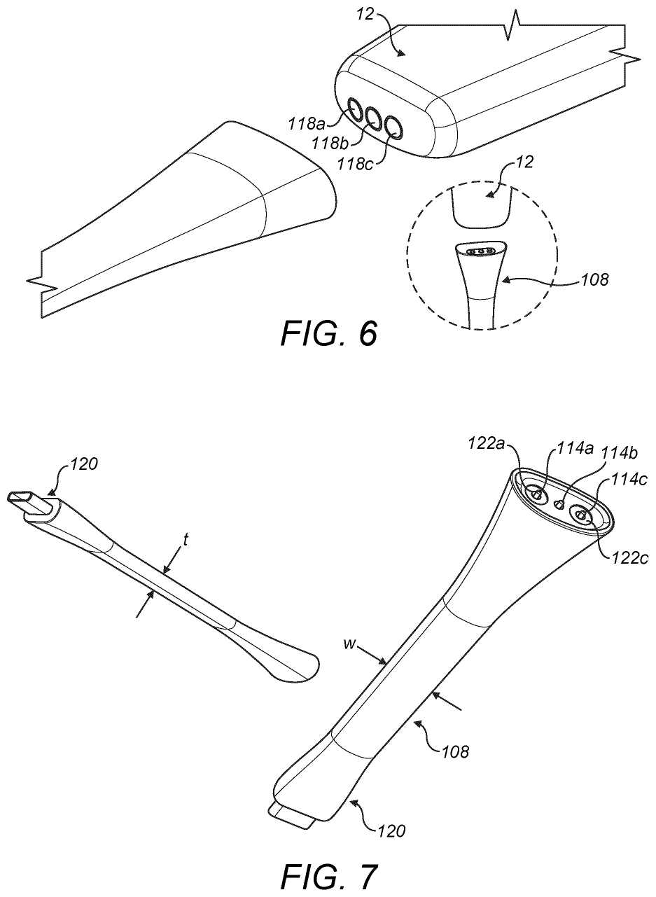

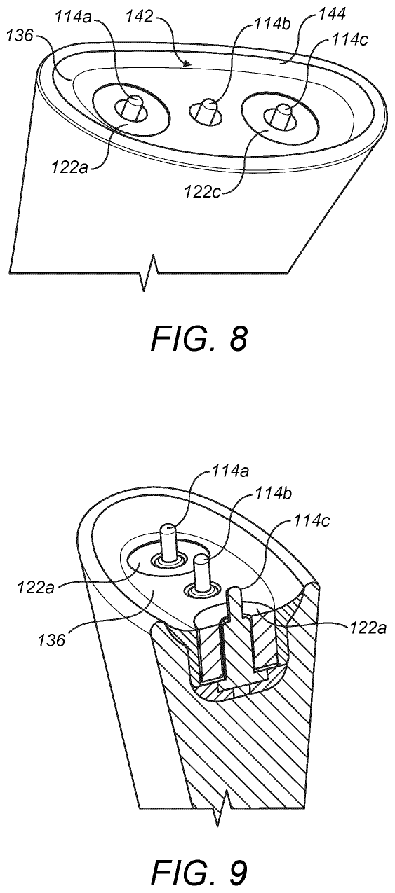

Referring now to FIGS. 5-9 and 11, those Figures show a further example of a charging system 100 with a different arrangement of device contacts. In view of the similarities between the system shown in FIGS. 1-4 and the system shown in FIGS. 5-9 and 11, in the interest of brevity, like description will not be repeated and like reference numerals are used to refer to like elements. It will be understood that the description of FIGS. 1-4 above applies equally to the system shown in FIGS. 5-9 and 11, mutatis mutandis.

The charging system of FIGS. 5-9 and 11 differs from that of FIGS. 1-4 in that the first connector portion 104 further includes a third device contact 118c in addition to first and second device contacts 118a, 118b. The third device contact 118c is of the same polarity as the first device contact 118a, so that the contact arrangement is reversible (i.e. has rotational symmetry of order two).

In this example, the first and third device contacts 118a, 118c mirror the locations of the first and third contact pins 114a, 114c such that when the charging cable 108 is connected to the device 12 the first device contact 118a electrically couples with the first contact pin 114a and the third device contact 118c electrically couples with the third contact pin 114c. As in the example described above, the second device contact 118b is located so as to electrically couple to the second contact pin 114b. However, in this case the second device contact 118b is in the form of a plate contact rather than a contact pin.

In the example shown, the first and third contact pins 114a, 114c, are equally spaced on opposite sides of the second contact pin 114b, such that the three contact pins of the charging cable 100 lie in a plane that comprises the longitudinal axis 134 of the cable. In addition to rotational symmetry, this arrangement ensures the contact pins are symmetrical about a line of symmetry passing through the second contact pin 114b and perpendicular to the longitudinal axis, which makes for a more compact cable. Similarly, the first and third device contacts 118a, 118c, are equally spaced on opposite sides of the second device contact 118b, such that the three device contacts lie in a plane that comprises the longitudinal axis 129 of the device. In this case, the longitudinal axes 129, 134 of the device and the cable substantially coincide when the cable is connected to the device.

As in the previous example, the first device contact overlies a third securing magnet 126a. However, in the present example the first connector part additionally includes a fourth securing magnet 126c, with the third device contact overlying the fourth securing magnet 126c. The device contacts are electrically isolated from one other by insulation 128. All three device contacts are flush with the device housing to present a smooth outer surface of the end part of the device, as described above.

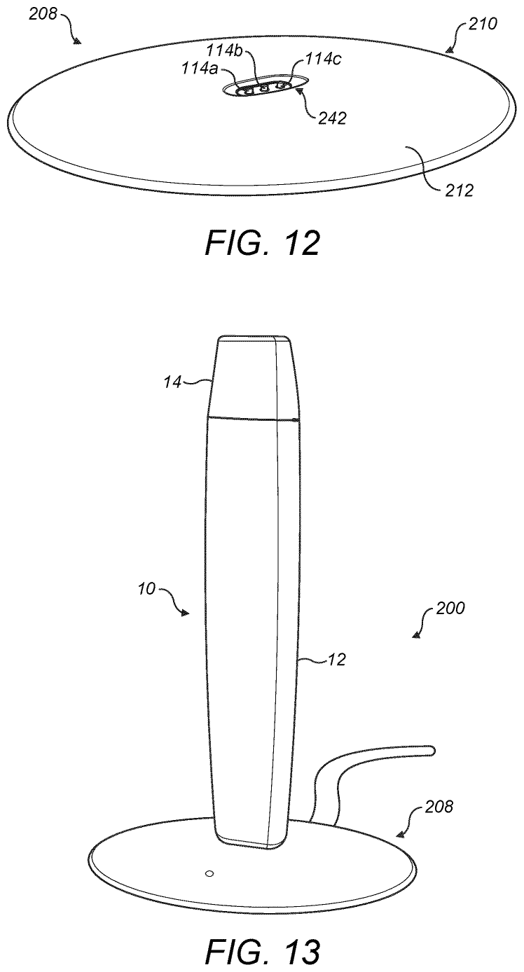

Referring now to FIGS. 12 and 13, those Figures show a further example of a charging system 100, in which the charging connector is included in a charging dock 208. In view of the similarities between the systems shown in FIGS. 1-11 and the system 1 shown in FIGS. 12-13, in the interest of brevity, like description will not be repeated and like reference numerals are used to refer to like elements. It will be understood that the description of FIGS. 1-11 above applies equally to the system shown in FIGS. 12-13, mutatis mutandis.

The charging dock 208 includes a dock base 210 having a dock housing 212. A device interface part is comprised in an upper surface of the dock housing. As discussed above, the device interface part includes three contact pins 114, namely a first contact pin 114a having a first polarity, a second contact pin 114b having a second polarity opposite to the first polarity, and a third contact pin 114c having the same polarity as the first contact pin (i.e. also having the first polarity). The contact pins 114 are comprised within a first portion of a charging circuit, as discussed above, and include securing magnets (not visible), as discussed above.

The contact pins 114 are located in a recess 242, which is shaped to receive an end portion of an aerosol generating device 12 in the same manner as discussed above. As can be seen in FIG. 13, when an aerosol device is received in the recess it is held upright, with its longitudinal axis substantially perpendicular to a surface on which the charging dock is located. Due to the shallow profile of the recess, substantially the entire device 12 is visible during charging.

Although the charging connectors above have been described in relation to an aerosol generating device comprising a liquid reservoir and a resistive heater it will be appreciated that this is not essential, and the charging connector could be used in other types of aerosol forming devices such as heat-not-burn devices, and/or devices including an inductive heating system.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments. Any combination of the above-described features in all possible variations thereof is encompassed by the present disclosure unless otherwise indicated herein or otherwise clearly contradicted by context.

1. A charging system for an aerosol generating device, the charging system comprising:
a charger having a device interface part, the charger comprising a first portion of a charging circuit, said first portion of the charging circuit comprising a first contact pin having a first polarity, a second contact pin having a second polarity opposite to the first polarity, and a third contact pin having the same polarity as the first contact pin;
an aerosol forming device having a device housing and comprising a second portion of the charging circuit, said second portion of the charging circuit including a first device contact and a second device contact;
wherein the device interface part of the charger further comprises a first securing magnet or group of magnets arranged adjacent to, the first contact pin, and a second securing magnet or group of magnets arranged adjacent to the third contact pin, the charger being releasably securable to the aerosol generating device using the first and second magnets or groups of magnets;
wherein the first device contact is located so as to form an electrical connection with the first contact pin and/or third contact pin and the second device contact is located so as to form an electrical connection with the second contact pin when the charger is releasably secured to the aerosol forming device, in order to complete a charging circuit; and
wherein the charger comprises a recess having a recess surface shaped to receive an end portion of the device housing when the charger is releasably secured to the aerosol forming device, the first, second and third contact pins protruding from the recess surface

2. The charging system of claim 1, wherein the charger is a charging cable, a charging dock or a charging case.

3. The charging system of claim 1, or wherein the aerosol forming device includes a third securing magnet, wherein the first device contact overlies the third securing magnet.

4. The charging system of claim 1, wherein the first and third contact pins are equally spaced on opposite sides of the second contact pin.

5. The charging system of claim 1, wherein the first device contact surrounds the second device contact, such that the first device contact forms the electrical connection with both the first contact pin and third contact pin when the charger is releasably secured to the aerosol forming device.

6. The charging system of claim 1, wherein the aerosol forming device further includes a third device contact and a fourth securing magnet, the third device contact overlying the fourth securing magnet, wherein the first and third device contacts are equally spaced on opposite sides of the second device contact.

7. The charging system of claim 1, wherein the device contacts are flush with an external surface of an end portion of the aerosol generating device.

8. The charging system of claim 1, wherein the recess surface is curved and comprises no angles or corners.

9. The charging system of claim of claim 1, wherein:
(i) the recess surface is concave, and includes a flattened region including the contact pins; and/or
(ii) the end portion of the device housing is convex, and includes a flattened region including the device contacts.

10. The charging system of claim 1, wherein the recess defines a shallow cavity, and wherein a depth of the cavity is less than 5 mm.

11. The charging system of claim 1, wherein the charger is a charging cable including an outer surface shaped to blend smoothly into an external surface of the aerosol generating device when the end portion of the device is located within the recess.

12. The charging system of claim 1, wherein the charger is a charging cable including a cable part having a thickness and a width, and wherein a cross-section of the cable part is flattened such that the width is at least 1.5 times the thickness,

13. The charging system of claim 1, wherein the charger is a charging cable and the device interface part is located at a first end of the cable part and the charging cable further comprises a power connector located at a second end of the cable part and electrically connected to the first portion of the charging circuit.

14. The charging system of claim 1, wherein the charger is a charging dock and the device interface part is located in an upper surface of a dock housing.

15. The charging system of claim 1, wherein the aerosol generating device further includes a rechargeable battery operable to be electrically connected to the second portion of the charging circuit.
